(19) United States
(12) Patent Application Publication
(10) Pub. No.: US 2014/0098725 A1
(43) Pub. Date: Apr. 10, 2014

(54) CONTROLLING TRANSMISSION OF PROTOCOL DATA UNITS

(71) Applicant: QUALCOMM INCORPORATED, San Diego, CA (US)

(72) Inventors: Tevfik Yucek, Santa Clara, CA (US); Vincent Knowles Jones, IV, Redwood City, CA (US); Simone Merlin, San Diego, CA (US)

(73) Assignee: QUALCOMM Incorporated, San Diego, CA (US)

(21) Appl. No.: 13/857,852

(22) Filed: Apr. 5, 2013

Related U.S. Application Data
(63) Continuation-in-part of application No. 13/710,136, filed on Dec. 10, 2012.
(60) Provisional application No. 61/712,191, filed on Oct. 10, 2012.
(60) Provisional application No. 61/722,697, filed on Nov. 5, 2012.

(51) Int. Cl. H04W 52/02

(52) U.S. Cl. CPC H04W 52/0229
USPC 370/311

(57) ABSTRACT

A method and system are disclosed that allow for the control of transmission characteristics associated with an exchange of protocol data units (PDUs) between a first wireless device and a second wireless device. The first wireless device determines a recovery time period and transmits the recovery time period to the second wireless device. The second wireless device may determine a time when the first wireless device enters the sleep state, wait for the recovery time period after the determined time, and then transmit a number of PDUs to the first wireless device after an expiration of the recovery time period.

### CROSS-REFERENCE TO RELATED APPLICATIONS

This application is a continuation-in-part of, and claims the benefit under 35 USC 120, of the co-pending and commonly owned U.S. patent application Ser. No. 13/710,136 entitled “METHOD FOR CONTROLLING TRANSMISSION OF PROTOCOL DATA UNITS” filed on Dec. 10, 2012, which in turn claims the benefit under 35 USC 119(e) of the co-pending and commonly owned U.S. Provisional Application No. 61/712,191 entitled “METHOD FOR CONTROLLING TRANSMISSION OF PROTOCOL DATA UNITS” filed on Oct. 10, 2012, and claims the benefit under 35 USC 119(e) of the co-pending and commonly owned U.S. Provisional Application No. 61/722,697 entitled “METHOD FOR CONTROLLING TRANSMISSION OF PROTOCOL DATA UNITS” filed on October Nov. 5, 2012; the entireties of all of which are incorporated by reference herein.

### TECHNICAL FIELD

The present embodiments relate generally to wireless networks, and specifically to controlling transmission conditions of protocol data units (PDUs) between wireless devices.

### BACKGROUND OF RELATED ART

Wireless access points (APs) may periodically transmit beacon frames to advertise the presence of wireless local area networks (WLANs). Wireless stations (STAs) may detect a beacon frame from an AP and transmit a response frame back to the AP to establish a wireless communication channel or link with the AP. However, the STA may not be able to control the length or size of data units transmitted from the AP to the STA, which may be problematic if the STA is not able to sustain data transmission and/or reception operations for periods of time expected by the AP. In addition, it may be desirable for the STA to not receive and/or transmit data during selected times.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A wireless system is disclosed that enables a first wireless device such as a station (STA) to control the transmission conditions associated with the exchange of protocol data units (PDUs) between the first wireless device and a second wireless device such an access point (AP) or another STA. In accordance with the present embodiments, the first wireless device can determine or retrieve from memory one or more transmission conditions that are dependent, at least in part, upon one or more hardware constraints of the first wireless device. These hardware constraints may affect how long the first wireless device can spend transmitting and/or receiving data units such as protocol data units (PDUs). For example, wireless devices powered by small batteries (e.g., coin cell batteries) may overheat and/or may experience a reduced power supply when continuously transmitting or receiving data for more than a certain time period. As a result, the first wireless device may not be able to sustain PDU transmission or reception operations for as long as the second wireless device can (e.g., especially where the first wireless device is a mobile STA having a small battery and the second wireless device is an access point).

The first wireless device may embed its transmission conditions into a frame to be sent to the second wireless device. The transmission conditions may include, for example, (i) a maximum duration of time that the first wireless device can spend receiving an individual PDU from another wireless device, (ii) a maximum duration of time that the first wireless device can spend transmitting a PDU to another wireless device, and/or (iii) a minimum duration of time that the other wireless device should wait after the transmission of a PDU to the first wireless device before sending a subsequent PDU to the first wireless device. In addition, it may be desirable for the STA to not receive and/or transmit data during selected times. The frame may be any suitable frame including, for example, an association request frame, a probe REQ frame, a response frame, a management frame, a control frame, and/or a data frame, and the transmission conditions may be embedded into a capabilities element, a new information element, and/or another suitable field of the frame.

Upon receipt of the transmission conditions from the first wireless device, the second wireless device may store the transmission conditions in a suitable look-up table. For some embodiments, the look-up table may include a plurality of entries each for storing the transmission conditions for a corresponding other wireless device (e.g., a mobile station and/or an access point). Then, in response to the transmission conditions, the second wireless device may selectively modify its data transmission, reception, and/or processing behavior when exchanging data with the first wireless device so that the first wireless device may process data such as PDUs according to its own transmission conditions. In this manner, the wireless devices may exchange PDUs in a manner that does not undesirably reduce the power supply or overheat either of the wireless devices.

### BRIEF DESCRIPTION OF THE DRAWINGS

The present embodiments are illustrated by way of example and are not intended to be limited by the figures of the accompanying drawings, where:

FIG. 1 shows a block diagram of a WLAN system within which the present embodiments may be implemented;

FIG. 2 shows a block diagram of a wireless station (STA) in accordance with some embodiments;

FIG. 3 shows a block diagram of an access point (AP) in accordance with some embodiments;

FIG. 4A depicts a transmission conditions table in accordance with some embodiments;

FIG. 4B depicts a transmission conditions table in accordance with other embodiments;

FIG. 4C depicts an activity specification element in accordance with some embodiments;

FIG. 5A is an illustrative flow chart depicting an exemplary data exchange between wireless devices in accordance with some embodiments;

FIG. 5B is an illustrative flow chart depicting an exemplary data exchange between wireless devices in accordance with other embodiments;

FIG. 6A shows a sequence diagram depicting an exchange of transmission conditions between wireless devices in accordance with some embodiments; and

FIG. 6B shows a sequence diagram depicting an exchange of transmission conditions between wireless devices in accordance with other embodiments.

Like reference numerals refer to corresponding parts throughout the drawing figures.

### DETAILED DESCRIPTION

The present embodiments are described below in the context of data exchanges between Wi-Fi enabled devices for simplicity only. It is to be understood that the present embodiments are equally applicable to data exchanges using signals of other various wireless standards or protocols. As used herein, the terms WLAN and Wi-Fi can include communications governed by the IEEE 802.11 family of standards, Bluetooth, HiperLAN (a set of wireless standards, comparable to the IEEE 802.11 standards, used primarily in Europe), and other technologies having relatively short radio propagation range. In addition, although described herein in terms of exchanging protocol data units (PDUs) between wireless devices, the present embodiments may be applied to the exchange of any data, packet, and/or frame between wireless devices. Thus, as used herein, the term “PDU” may refer to any data frame, data packet, or data unit transmitted between wireless devices.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The present embodiments are not to be construed as limited to specific examples described herein but rather to include within their scopes all embodiments defined by the appended claims.

As mentioned above, some wireless devices may have hardware resource constraints that affect how long they can spend transmitting and/or receiving data units such as data frames or data packets. For example, wireless devices powered by small batteries (e.g., coin cell batteries) may overheat and/or may experience a reduced power supply when continuously transmitting or receiving data for more than a certain time period. In addition, wireless communication protocols such as those embodied by the IEEE 802.11 family of standards may specify different periods of time that a wireless device may spend transmitting and/or receiving data such as a protocol data unit (PDU). For example, while the 802.11ac wireless communication standard allows the transmission of a physical layer convergence procedure PDU (PPDU) to last up to 6 ms, the 802.11 ah wireless communication standard may allow the transmission of a PPDU to last up to 21 ms. As a result, a wireless device associated with a particular WLAN (or participating in a Wi-Fi peer-to-peer or ad hoc network) may not be able to sustain the transmission and/or reception of a PDU for the maximum period of time allowed by the applicable wireless communication standard without overheating and/or experiencing a degradation of its power supply.

Accordingly, a wireless network system is disclosed herein that allows a wireless device such as a station (STA) to control the transmission conditions associated with the exchange of data such as protocol data units (PDUs) between the STA and another wireless device such as an access point (AP) or another STA. In accordance with the present embodiments, the STA may determine a number of transmission conditions that are dependent upon one or more hardware constraints of the STA (e.g., battery type and/or size, maximum sustained current, overheating parameters, and so on), and then communicate the transmission conditions to the other wireless device. In response thereto, the other wireless device may selectively modify its data transmission, reception, and/or processing behavior when exchanging data with the STA so that the other wireless device processes PDUs according to the STA's transmission conditions. In this manner, the STA may exchange PDUs with the other wireless device in a manner that does not undesirably reduce the STA's power supply or overheat the STA.

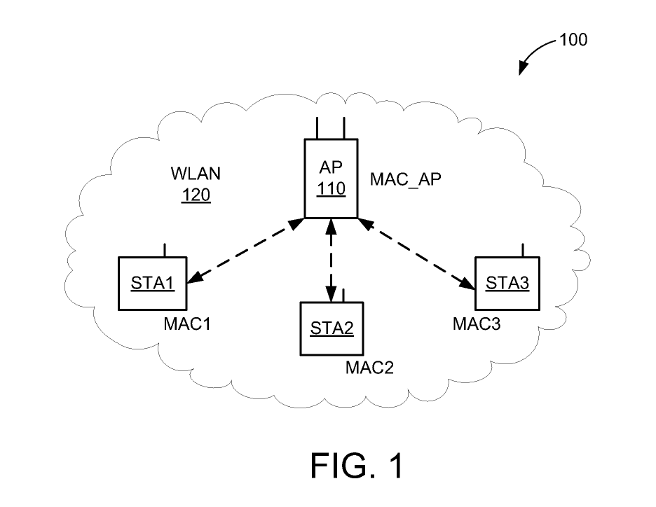

FIG. 1 is a block diagram of a wireless network system 100 within which the present embodiments may be implemented. The system 100 is shown to include three wireless stations STA1-STA3, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 can be formed by any number of access points such as AP 110. The AP 110 is assigned a unique MAC address (MAC_AP) that is programmed therein by, for example, the manufacturer of the access point. Similarly, each of STA1-STA3 is also assigned a unique MAC address (MAC1-MAC3, respectively). Each MAC address, which may be commonly referred to as the “burned-in address,” the organizationally unique identifier (OUI), or the Basic Service Set ID (BSSID), in one embodiment includes six bytes of data. The first 3 bytes of the MAC address may identify which organization manufactured the device, and may be assigned to such organizations by the Institute of Electrical and Electronic Engineers (IEEE). The second 3 bytes of the MAC address, which may be referred to as the network interface controller (NIC) specific bytes, may be used to uniquely identify the individual device.

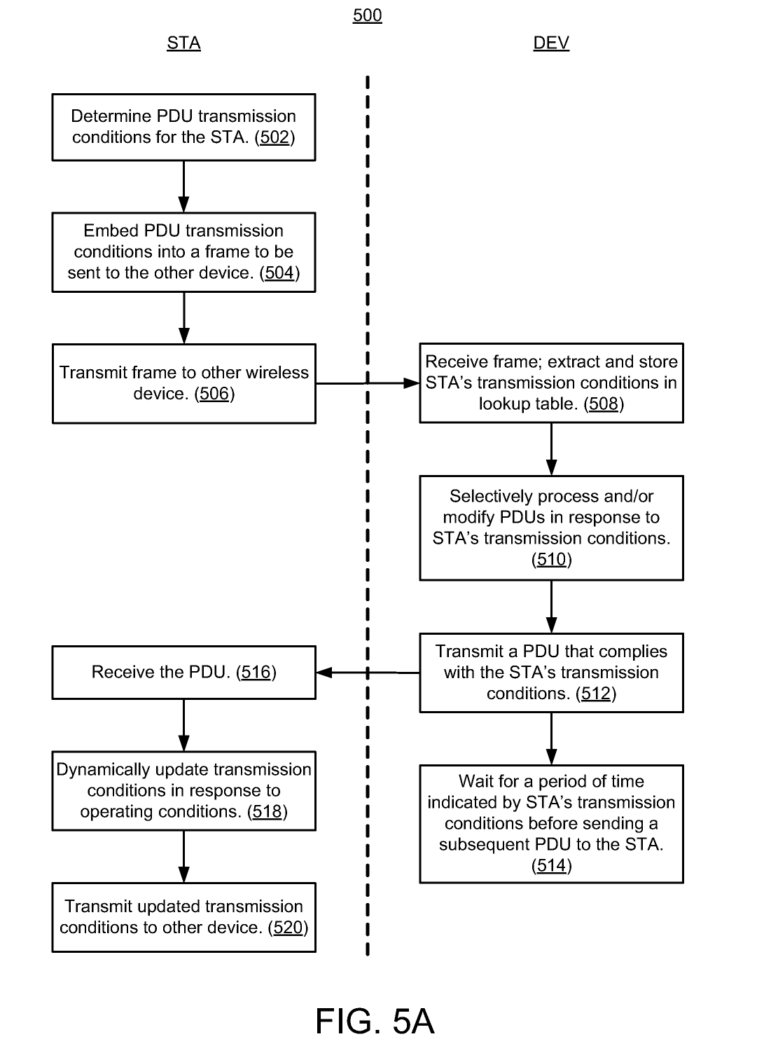

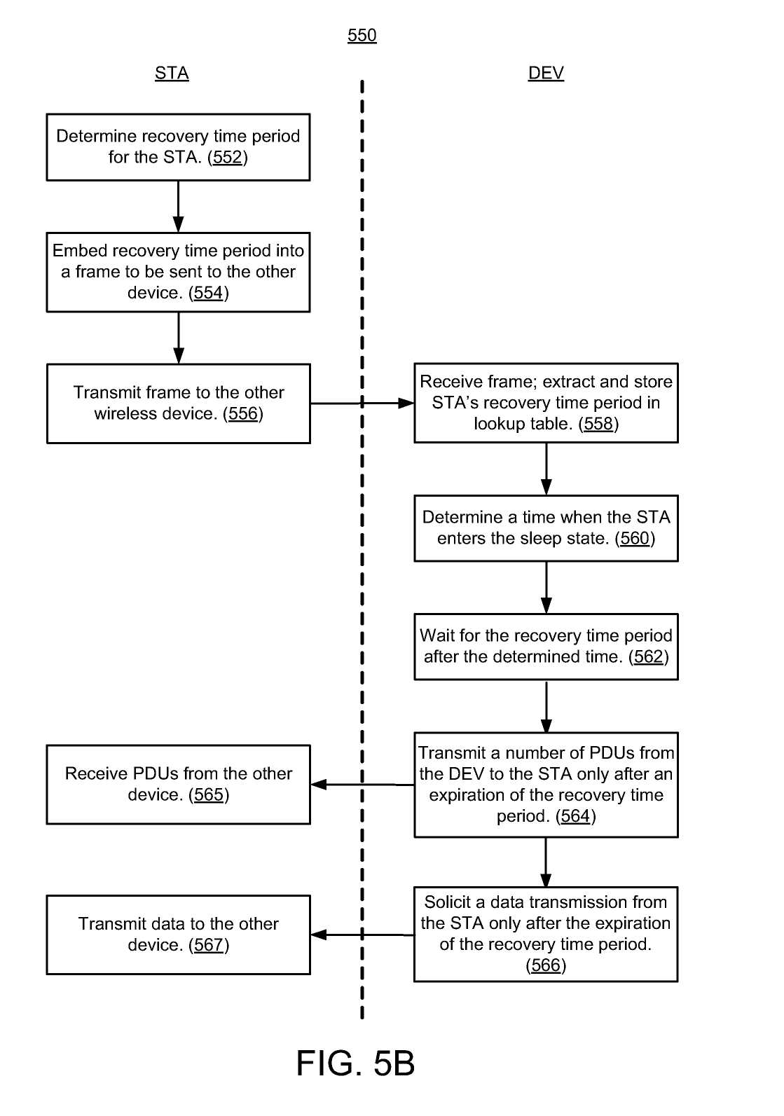

The stations STA1-STA3 may be any suitable Wi-Fi enabled wireless devices including, for example, network-enabled sensors, memory tags (RFID tags), smart meters, cell phones, personal digital assistants (PDAs), tablet devices, laptop computers, or the like. For at least some embodiments, stations STA1-STA3 may include a transmitter/receiver circuit, one or more processing resources, one or more memory resources, and a power source (e.g., battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 5A-5B.

The AP 110 may be any suitable device that allows one or more wireless devices to connect to a network (e.g., a LAN, WAN, MAN, and/or the Internet) via AP 110 using Wi-Fi, Bluetooth, or any other suitable wireless communication standards. For at least one embodiment, AP 110 may include a network interface, one or more processing resources, and one or more memory sources. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 5A-5B.

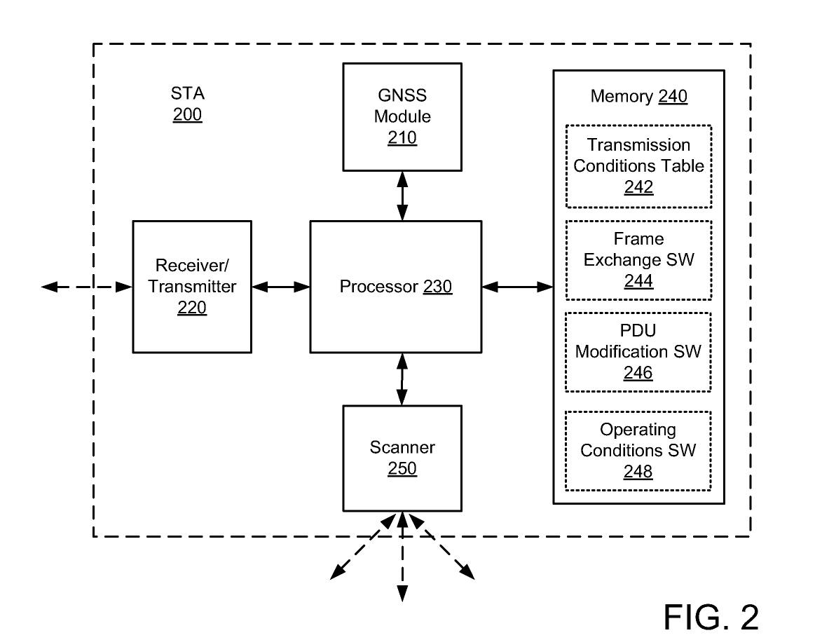

FIG. 2 shows a STA 200 that is one embodiment of at least one of the stations STA1-STA3 of FIG. 1. The STA 200 includes a global navigation satellite system (GNSS) module 210, a transmitter/receiver circuit 220, a processor 230, a memory 240, and a scanner 250. The transmitter/receiver circuit 220, which may also be referred to as a transceiver circuit, can be used to transmit signals to and receive signals from AP 110 (see also FIG. 1). Scanner 250, which is well-known, can be used to scan the surrounding environment to detect and identify nearby access points (e.g., access points within range of STA 200). For some embodiments, the scanner 250 can search for nearby access points by periodically transmitting MAC address request frames (e.g., probe requests). An AP within range of STA 200 receives one or more of the requests and responds by transmitting its MAC address to the STA 200. If the STA 200 has line-of-sight with a suitable number (e.g., 3 or more) of navigation satellites, the GNSS module 210 can determine the current location of the STA 200 using triangulation techniques, and can then provide the location information to processor 230 for storage in memory 240.

Memory 240 may include a transmission conditions table 242 that stores a number of transmission conditions determined by and/or associated with STA 200. The transmission conditions may include information indicating (i) a maximum duration of time that STA 200 can spend receiving an individual PDU from another wireless device (e.g., from AP 110 or from another STA), (ii) a maximum duration of time that STA 200 can spend transmitting a PDU to the other wireless device, and/or (iii) a minimum duration of time that the other wireless device should wait after the transmission of a PDU before sending a subsequent PDU to STA 200. The transmission conditions table 242 may also store additional information including, for example, transmission conditions for one or more other wireless devices and/or compliance information indicating whether the one or more other wireless devices are able to exchange PDUs with STA 200 according to STA 200's transmission conditions.

Memory 240 may also include a non-transitory computer-readable medium (e.g., one or more nonvolatile memory elements, such as EPROM, EEPROM, Flash memory, a hard drive, and so on) that can store the following software modules:
a frame exchange software module 244 to facilitate the creation and/or exchange of various frames (e.g., probe REQ frames, association request frames, response frames, management frames, control frames, data frames, and/or other suitable types of frames) with AP 110 and/or one or more other STAs, for example, as described for operations 504 and 506 of FIG. 5A and/or for operations 554, 556, 565, and 567 of FIG. 5B;
a PDU modification software module 246 to selectively modify the size/length of PDUs transmitted from STA 200 and/or to selectively modify how long STA 200 waits between transmissions of successive PDUs to another wireless device, for example, as described for operation 510 of FIG. 5A; and
an operating conditions software module 248 to determine and/or selectively update one or more transmission conditions in response to a number of operating conditions (e.g., temperature, battery life, packet loss rates, encoding techniques), for example, as described for operations 502 and 518 of FIG. 5A and/or for operation 552 of FIG. 5B.
   The frame exchange software module 244 includes instructions that, when executed by processor 230, can cause STA 200 to perform the corresponding functions. The PDU modification software module 246 includes instructions that, when executed by processor 230, can cause STA 200 to perform the corresponding functions. The operating conditions software module 248 includes instructions that, when executed by processor 230, can cause STA 200 to perform the corresponding functions.

Processor 230, which is coupled to transmitter/receiver circuit 220, GNSS module 210, memory 240, and scanner 250, can be any suitable processor capable of executing scripts or instructions of one or more software programs stored in STA 200 (e.g., within memory 240). For example, processor 230 can execute frame exchange software module 244 to facilitate the creation and/or exchange of association request frames, probe REQ frames, response frames, management frames, control frames, and/or data frames with the AP 110 and/or one or more other STAs. Processor 230 can also execute PDU modification software module 246 to selectively modify the size/length of PDUs transmitted from STA 200 and/or to selectively modify how long STA 200 waits between transmissions of successive PDUs to another wireless device. Processor 230 can also execute operating conditions software module 248 to determine and/or selectively update one or more transmission conditions in response to a number of operating conditions (e.g., temperature, battery life, packet loss rates, encoding techniques) of STA 200.

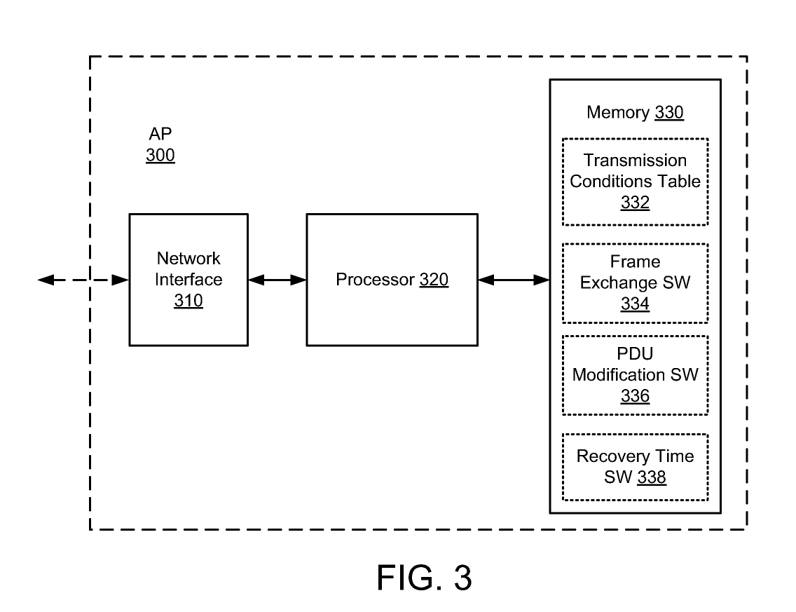

FIG. 3 shows an AP 300 that is one embodiment of AP 110 of FIG. 1. AP 300 includes a network interface 310, a processor 320, and a memory 330. The network interface 310 can be used to communicate with a WLAN server (not shown for simplicity) associated with WLAN 120 of FIG. 1 either directly or via one or more intervening networks and to transmit signals. Processor 320, which is coupled to network interface 310 and memory 330, can be any suitable processor capable of executing scripts or instructions of one or more software programs stored in AP 300 (e.g., within memory 330).

Memory 330 includes a transmission conditions table 332 that stores transmission conditions for a number of wireless devices such as stations STA1-STA3 of FIG. 1 and/or other access points. The transmission conditions may include information for each wireless device indicating (i) a maximum duration of time that the wireless device can spend receiving an individual PDU from AP 300, (ii) a maximum duration of time that the wireless device can spend transmitting a PDU to AP 300, and/or (iii) a minimum duration of time that AP 300 should wait after the transmission of a PDU to the wireless device before sending a subsequent PDU to the wireless device.

The transmission conditions table 332 may also store additional information including, for example, transmission conditions for AP 300 and/or for a number of other access points. For some embodiments, each entry of the transmission conditions table 332 includes a device field to store the name of a corresponding wireless device, an ID field to store the MAC address of the corresponding wireless device, a number of condition fields to store various transmission conditions for the corresponding wireless device, and/or a compliance field to store information indicating whether AP 300 can exchange data unit with the corresponding wireless device according to its transmission conditions.

Memory 330 also includes a non-transitory computer-readable medium (e.g., one or more nonvolatile memory elements, such as EPROM, EEPROM, Flash memory, a hard drive, and so on) that can store the following software modules:
a frame exchange software module 334 to facilitate the creation and/or exchange of probe frames, response frames, management frames, data frames, and/or other suitable types of frames with other wireless devices, for example, as described for operation 512 of FIG. 5A and/or for operations 558, 564, and 566 of FIG. 5B;
a PDU modification software module 336 to selectively modify the size/length of PDUs transmitted from AP 300 and/or to selectively modify how long AP 300 waits between transmissions of successive PDUs to another wireless device, for example, as described for operations 510 and 514 of FIG. 5A; and
a recovery time software module 338 to determine a time when the STA enters and/or exits the sleep state and to selectively wait for the recovery time period to transmit data to and/or solicit data transmissions from the STA, for example, as described for operations 560 and 562 of FIG. 5B.
   The frame exchange software module 334 includes instructions that, when executed by processor 320, cause AP 300 to perform the corresponding functions. The PDU modification software module 336 includes instructions that, when executed by processor 320, can cause AP 300 to perform the corresponding functions.

Processor 320, which is coupled to network interface 310 and memory 330, can be any suitable processor capable of executing scripts or instructions of one or more software programs stored in AP 300 (e.g., within memory 330). For example, processor 320 can execute frame exchange software module 334 to facilitate the creation and/or exchange of probe frames, response frames, management frames, data frames, and/or other suitable types of frames with one or more STAs or another AP. Processor 320 can also execute PDU modification software module 336 to selectively modify the size/length of PDUs transmitted from AP 300 and/or to selectively modify how long AP 300 waits between transmissions of successive PDUs to another wireless device.

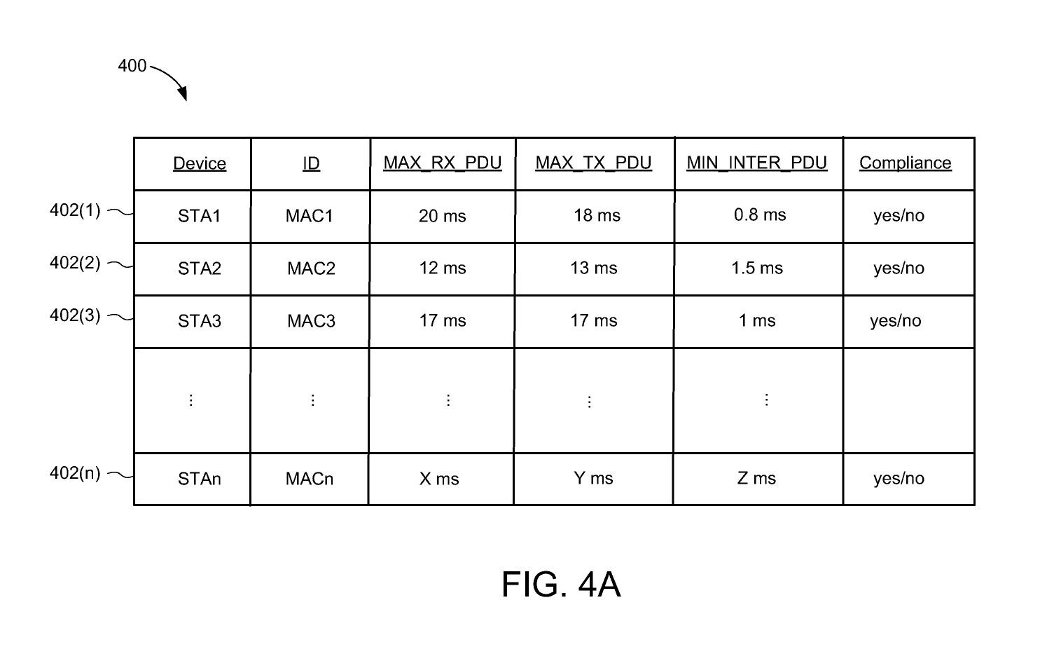

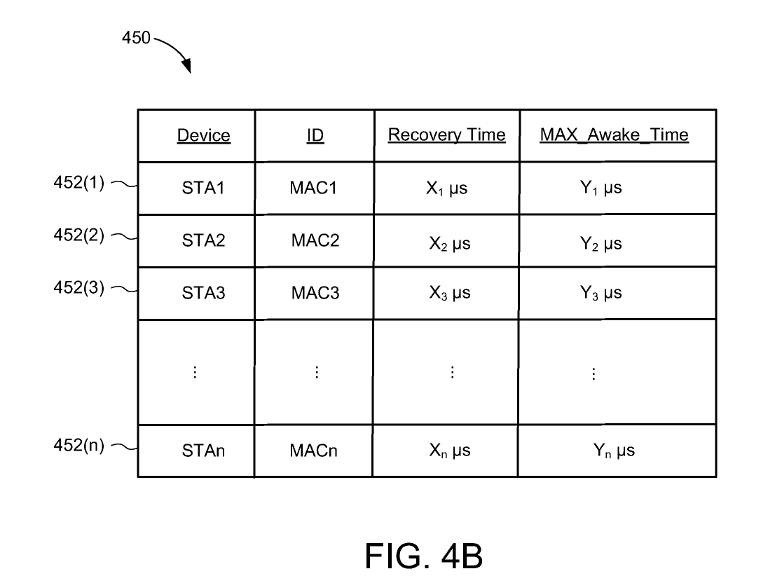

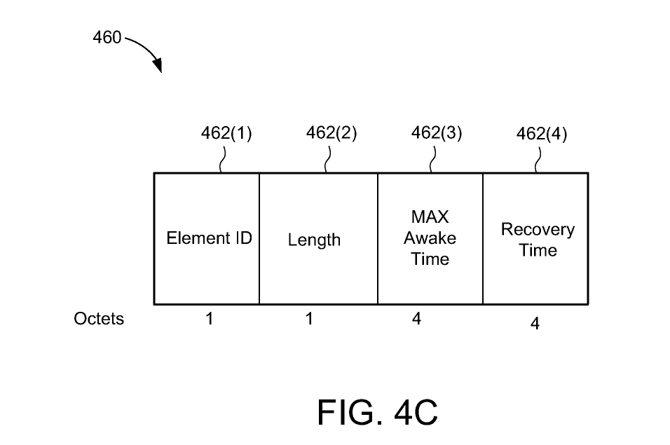

FIG. 4A depicts a transmission conditions table 400 that is one embodiment of the transmission conditions table 332 of AP 300 (see also FIG. 3). For at least one embodiment, transmission conditions table 400 may also be used as the transmission conditions table 242 of STA 200 (see also FIG. 2). The transmission conditions table 400, which may be any suitable look-up table, includes a plurality of entries 402(1)-402(n) for storing transmission conditions for a corresponding number of wireless devices. Note that for the exemplary embodiment of FIG. 4A, entries 402(1)-402(n) store transmission conditions for stations such as STA1-STA3 of FIG. 1; for other embodiments, one or more of entries 402 may store transmission conditions for one or more corresponding access points.

Each entry 402 of transmission conditions table 400 includes a device field, an ID field, a first conditions field (MAX_RX_PDU), a second conditions field (MAX_TX_PDU), a third conditions field (MIN_INTER_PDU), and a compliance field. The device field is to store a name or ID of a corresponding wireless device. The ID field is to store the MAC address of a corresponding wireless device. The first conditions field is to store an indication of a maximum duration of time (MAX_RX_PDU) that the corresponding wireless device can spend receiving an individual PDU from another wireless device. The second conditions field is to store an indication of a maximum duration of time (MAX_TX_PDU) that the corresponding wireless device can spend transmitting a PDU to another wireless device. The third conditions field is to store an indication of a minimum duration of time (MIN_INTER_PDU) that AP 300 should wait after the transmission of a PDU to the corresponding wireless device before sending a subsequent PDU to the corresponding wireless device. For example, due to hardware constraints, the corresponding wireless device may require a minimum duration of time to recover from a previous reception of a PDU from AP 300. The compliance field is to store information (e.g., yes or no) indicating whether AP 300 is able to comply with the transmission conditions for the corresponding wireless device.

For example, as depicted in FIG. 4A, transmission conditions table 400 may store information for STA1 that includes its name (STA1), its MAC address (MAC1), the duration of time for MAX_RX_PDU (e.g., 20 ms), the duration of time for MAX_TX_PDU (e.g., 18 ms), the wait time between transmissions of successive PDUs from AP 300 (e.g., 0.8 ms), and whether AP 300 is able to comply with the transmission conditions for STA1.

The durations of time stored in transmission conditions table 400 may be expressed as an absolute unit of time (e.g., in μs or ms) or as a relative unit of time. Thus, for some embodiments, the durations of time may be stored in transmission conditions table 400 as a number of constant time periods (e.g., a symbol time, a slot time, or a time unit (TU) such as milliseconds), while for other embodiments, the durations of time may be stored in transmission conditions table 400 as a fraction or percentage of a relative term (e.g., as a percentage of a maximum PDU length or size). Alternatively, the durations of time stored in transmission conditions table 400 may be expressed as the index of a pre-defined list of possible values (e.g., the values either indicated by AP 300 or defined in the applicable wireless protocol).

For other embodiments, the STA's transmission conditions may include a MAX_RX_PDU_Bytes value that indicates the maximum number of bytes that PDUs sent from AP 300 to the STA may contain. The value of MAX_RX_PDU_Bytes may indicate the maximum number of bytes contained in the packet service data unit (PSDU), the maximum number of bytes contained in a MAC packet data unit (MPDU), and/or the maximum number of bytes contained in an A-MSDU. The number of bytes may be signaled as a number of bytes or as an index in a list of predefined values.

For other embodiments, the STA's transmission conditions may include a MAX_Awake_Time value that indicates a maximum time period during which the STA is to be in an awake state to receive a number of PDUs and/or to sense the wireless communication medium (e.g., associated with WLAN 120 of FIG. 1). For these embodiments, the MAX_Awake_Time value provided by the STA may instruct AP 300 that the STA is not to remain in the awake state for longer than the maximum time period indicated by the value of MAX_Awake_Time. Thus, upon receiving the MAX_Awake_Time value from the STA, AP 300 is to initiate transmission of a number of PDUs to the STA only if all of the PDUs can be received by the STA within a reception period equal to a Wakeup_Time+MAX_Awake_Time, where the Wakeup_Time indicates the time at which the STA transitions from a Sleep state to the Awake state. For one embodiment, the value of Wakeup_Time is known to AP 300. For another embodiment, the value of Wakeup_Time may be provided to AP 300 by the STA.

The STA's transmission conditions may also (or alternatively) include a recovery time period (REC_PER) indicating a minimum duration of time that the STA is to not receive and/or transmit data units after entering a sleep (or doze) state. The value of REC_PER (e.g., as provided by the STA) may cause the AP 300 (or another STA operating in a peer-to-peer mode) to wait until after expiration of the recovery time period to transmit data units to the STA and/or to solicit data transmissions from the STA. Thus, after the STA enters the sleep state, the AP 300 (or another STA operating in a peer-to-peer mode) does not commence transmission of data units (e.g., PPDUs) to the STA until after expiration of the recovery time period (REC_PER), and/or does not cause the STA to transmit data units (e.g., PPDUs) to other devices until after expiration of the recovery time period (REC_PER).

For some embodiments, the AP 300 may include or be associated with a timer (not shown for simplicity) that begins counting time units when the STA enters the sleep state; when the timer reaches a count value corresponding to the value of the recovery time period (REC_PER), the timer may assert a ready signal indicating that the AP 300 may begin transmitting data units to the STA and/or that the AP 300 may solicit data transmissions from the STA.

The AP 300 may determine when the STA enters and/or exits the sleep state in a number of ways. For some embodiments, the AP 300 may determine the STA's Wakeup_Time in response to the STA's most recent transition from the sleep state to the awake state. For example, the AP 300 may determine the STA's Wakeup_Time in response to one or more of the following:
receiving a power-save (PS) Poll request or trigger frame from the STA (e.g., transmitted by the STA in response to a traffic indication map (TIM) bit indicating that the AP 300 has queued downlink data for the STA);
the start of the STA's MAX_Awake_Time;
the start time of a slot in the Restricted Access Window (RAW) of the STA; and
the AP 300′s target beacon transmission time (TBTT or DTIM TBTT) or schedule.

For other embodiments, the AP 300 may determine when the STA transitions from the awake state to the sleep state. For example, the AP 300 may determine the STA's sleep time (SLEEP_TIME) in response to one or more of the following:
receiving an acknowledgement (ACK) frame from the STA acknowledging reception of buffered downlink data (e.g., in response to a PS-Poll request sent from the STA);
receiving an ACK frame from the STA acknowledging reception of a frame having its End of Service Period (EOSP) bit asserted (e.g., set to 1);
a predefined duration after a Target Wake Time duration of time of the STA (e.g., modified in response to the STA's MAX_Awake_Time);
the end time of a slot in the RAW of the STA;
the end of transmission of a beacon frame from the AP 300; and
the end of transmission of broadcast data following a delayed traffic indication message (DTIM) from the AP 300.

FIG. 4B depicts a transmission conditions table 450 that is another embodiment of the transmission conditions table 332 of AP 300 (see also FIG. 3). For at least one embodiment, transmission conditions table 450 may also be used as the transmission conditions table 242 of STA 200 (see also FIG. 2). The transmission conditions table 450, which may be any suitable look-up table, includes a plurality of entries 452(1)-452(n) for storing transmission conditions for a corresponding number of wireless devices. Note that for the exemplary embodiment of FIG. 4B, entries 452(1)-452(n) store transmission conditions for stations such as STA1-STA3 of FIG. 1; for other embodiments, one or more of entries 452 may store transmission conditions for one or more corresponding access points.

Each entry 452 of transmission conditions table 450 includes a device field, an ID field, a recovery time field, and a MAX_Awake_Time field. The recovery time field stores a value for REC_PER for the corresponding STA, and the MAX_Awake_Time field stores a value of MAX_Awake_Time for the corresponding STA. For some embodiments, the table 450 may also store one or more of the transmission conditions described above with respect to FIG. 4A (e.g., one or more of MAX_RX_PDU, MAX_TX_PDU, MIN_INTER_PDU, the compliance field, and/or the MAX_Awake_Time). For at least one embodiment, the fields depicted in FIG. 4B may be stored in the table 400 of FIG. 4A.

FIG. 4C depicts an exemplary activity specification element 460 in accordance with some embodiments. The activity specification element 460, which may be used as the capabilities element, the information element, or any other suitable element within a frame transmitted from the STA, may be used to indicate values for the STA's MAX_Awake_Time and recovery time period (REC_PER). More specifically, the element 460 is shown to include a first field 462(1) to store an element ID, a second field 462(2) to store a length of the element 460, a third field 462(3) to store a value for MAX_Awake_Time, and a fourth field 462(4) to store a value for the recovery time period (REC_PER). For the example of FIG. 4C, first field 462(1) contains 1 octet, the second field 462(2) contains 1 octet, the third field 462(3) contains 4 octets, and the fourth field 462(4) contains 4 octets (although other field lengths may be used).

In operation, wireless devices such as AP 300 may use information stored in transmission conditions table 400 to selectively modify data units (e.g., PDUs or PPDUs) to be transmitted to one or more STAs according to transmission conditions provided by each of the STAs, even if the STAs have different transmission conditions. For example, when transmitting data to STA1 and STA2 (e.g., as unicast data), AP 300 may access the MAX_RX_PDU values for STA1 and STA2, and in response thereto (1) modify a PDU to be transmitted to STA1 so that it does not take longer than 20 ms for STA1 to receive the PDU and (2) modify a PDU to be transmitted to STA2 so that it does not take longer than 12 ms for STA2 to receive the PDU. For another example, AP 300 may access the MIN_INTER_PDU values for STA1 and STA2, and in response thereto (1) wait 0.8 ms after a first PDU has been transmitted to STA1 before transmitting a second PDU to STA1 and (2) wait 1.5 ms after a first PDU has been transmitted to STA2 before transmitting a second PDU to STA2.

In addition, for at least some embodiments, a STA may provide multiple durations of time for each transmission condition to AP 300 (or to another STA), thereby allowing the STA to support different MAX_RX_PDU times, different MAX_TX_PDU times, and/or different MIN_INTER_PDU times based on specific types of transmissions. For example, the values of one or more of MAX_RX_PDU, MAX_TX_PDU, and/or MIN_INTER_PDU for the STA may vary depending on the data encoding type (e.g., binary convolutional coding (BCC) encoding, low-density parity-check (LDPC) encoding, and so on), bandwidth or QoS parameters (e.g., best effort, guaranteed bandwidth), priority values, and/or the number of spatial streams of the PDU. For these embodiments, the transmission conditions table 400 may store, for each STA, a plurality of values for one or more of MAX_RX_PDU, MAX_TX_PDU, and/or MIN_INTER_PDU.

Further, wireless devices such as AP 300 may use information stored in transmission conditions table 450 to schedule and/or delay transmission of data units (e.g., PDUs or PPDUs) to one or more STAs according to the recovery time periods (REC_PER) provided by each of the STAs, even if the STAs have different transmission conditions. For example, when transmitting data to STA1 and STA2 (e.g., as unicast data), AP 300 may access the REC_PER values for STA1 and STA2, and in response thereto (1) wait to send the data units to STA1 until after expiration of the recovery time period associated with STA1 and (2) wait to send the data units to STA2 until after expiration of the recovery time period associated with STA2.

As mentioned above, embodiments of transmission conditions tables 400 and 450 may also be implemented as transmission conditions table 242 of STA 200 of FIG. 2, thereby allowing STA 200 to selectively modify data units (e.g., PDUs or PPDUs) to be transmitted to other wireless devices and/or to selectively wait a certain amount of time between transmitting successive data units to the other wireless devices.

Referring again to FIG. 1, each of stations STA1-STA3 may provide its transmission conditions to AP 110 before, during, and/or after a communication channel or link is established with AP 110. For example, each of STA1-STA3 may embed its transmission conditions in a suitable frame (e.g., an association request frame, a probe REQ frame, a response frame, a management frame, a control frame, and/or a data frame) sent to AP 110. Similarly, stations STA1-STA3 may exchange their transmission conditions with each other during peer-to-peer or ad-hoc communications between STA1-STA3. For some embodiments, access points such as AP 110 may exchange transmission conditions with each other either wirelessly (e.g., using WLAN 120) or through an associated WLAN server (not shown for simplicity).

An exemplary operation in which transmission conditions for a STA are provided to another wireless device (DEV) is described below with respect to the illustrative flow chart 500 of FIG. 5A. For the exemplary operation described below, the other wireless device (DEV) may be an access point (e.g., AP 110 of FIG. 1) and/or another wireless station (e.g., one of stations STA1-STA3 of FIG. 1).

First, the STA may determine, identify, or retrieve one or more transmission conditions for the STA (502). As mentioned above, the transmission conditions are based, at least in part, upon the STA's hardware constraints and may include information indicating (i) a maximum duration of time (MAX_RX_PDU) that the STA can spend receiving an individual PDU from another wireless device, (ii) a maximum duration of time (MAX_TX_PDU) that the STA can spend transmitting a PDU to the other wireless device, and/or (iii) a minimum duration of time (MIN_INTER_PDU) that the other wireless device should wait after the transmission of a first PDU to the STA before sending a subsequent PDU to the STA.

For some embodiments, the STA's transmission conditions may be predetermined and programmed (e.g., by the manufacturer of the STA) into memory resources of the STA (e.g., memory 240 of FIG. 2). For example, values of MAX_RX_PDU, MAX_TX_PDU, and/or MIN_INTER_PDU may be determined based upon the STA's specific battery features, hardware characteristics, and/or power consumption characteristics. During operation, the STA may retrieve the programmed transmission conditions from its memory resources. For other embodiments, the STA's transmission conditions may be determined by the STA and stored in its memory resources.

Next, the STA embeds the transmission conditions into a frame to be sent to the other wireless device DEV (504), and then transmits the frame (along with the embedded transmission conditions) to the other wireless device (506). As mentioned above, the frame sent from the STA to the DEV may be any suitable frame including, for example, association request frames, probe REQ frames, response frames, management frames, control frames, and/or data frames. For one example, if the DEV is an AP that has transmitted a beacon frame to the STA, the STA may embed the transmission conditions into a response frame sent back to the DEV. Alternatively, if the STA has not received a beacon frame, the STA may embed the transmission conditions into an association request frame or probe REQ frame to the DEV. For another example, if the DEV is another STA, then the STA may embed the transmission conditions into an association request frame and/or other suitable frames exchanged between the devices (e.g., in a peer-to-peer or ad hoc wireless network).

Note that the STA may embed values for one or more of its transmission conditions into the capabilities element of the frame sent to the DEV. Alternatively, the STA may embed values for one or more of its transmission conditions into a new information element of the frame sent to the DEV.

The DEV receives the frame from the STA, extracts the STA's transmission conditions from the frame, and then stores the STA's transmission conditions in its look-up table (e.g., transmission conditions table 332 of FIG. 3) (508). For example, as described above with respect to FIG. 4A, the DEV may use the STA's MAC address to access an entry 402 of transmission conditions table 400 that corresponds to the STA, and then store the STA's transmission conditions in the corresponding entry 402 of transmission conditions table 400.

Then, the DEV may selectively process and/or modify PDUs in response the STA's transmission conditions (510), and thereafter transmit to the STA one or more PDUs that comply with the STA's transmission conditions (512). More specifically, in response to the STA's transmission conditions, the DEV may selectively discard PDUs having a data size or length that would take the STA longer than MAX_RX_PDU to receive, or the DEV may selectively modify the length of the PDUs to comply with the MAX_RX_PDU value. For some embodiments, the DEV may identify PDUs that exceed the value of MAX_RX_PDU and then fragment the PDU's data (i.e., the MPDU) into two or more smaller PDUs that each complies with the value of MAX_RX_PDU. For broadcast or multicast traffic, the DEV may convert the PDUs into unicast PDUs and then fragment each unicast PDU into two or more smaller PDUs that comply with the STA's transmission conditions.

After the transmission of the PDU to the STA, the DEV may wait for a period of time indicated by the value of MIN_INTER_PDU before sending a subsequent PDU to the STA (514). For example, due to hardware constraints, the STA may require a minimum duration of time to recover from a previous reception of a PDU from the DEV. Thus, instructing the DEV to wait for the minimum duration of time may allow the STA's battery and/or operating voltage to recover (e.g., increase) to a suitable level that allows for the reception of a subsequent PDU from the DEV.

In addition, the DEV may also decide to (i) not send frames to the STA that require a response longer than MAX_TX_PDU, (ii) exclude the STA from data exchanges that are incompatible with the MAX_TX_PDU value for the STA, and/or (iii) specifically include the STA in data exchanges that optimize the performance of the STA.

Further, the DEV may delay transmission of data units to the STA until after expiration of the STA's recovery time period, for example, so that the STA may recover from transitioning from the sleep state to the awake state. The DEV may also delay soliciting transmissions from the STA until after expiration of the STA's recovery time period. For some embodiments, the STA's recovery time period may commence upon the STA entering the sleep state, and may therefore correspond to (1) a duration of the sleep state and (2) an additional time period at the beginning of the awake state. For other embodiments, the STA's recovery time period may commence upon the STA entering the awake state, and may therefore indicate an amount of time associated with the STA recovering from the wake-up operation.

The STA receives PDUs sent from the DEV (516). Thereafter, for some embodiments, the STA may dynamically update its transmission conditions in response to current operating conditions such as, for example, temperature, battery life, packet loss rates, encoding techniques, and so on (518). For example, if the operating temperature increases, the STA may reduce the stored values for MAX_RX_PDU and/or MAX_TX_PDU. For another example, if the STA's battery life unexpectedly decreases, the STA may reduce the stored values for MAX_RX_PDU and/or MAX_TX_PDU.

The STA may then transmit the updated transmission conditions to the DEV using request frames, management frames, control frames, response frames, and/or data frames in the manner described above (520).

Note that although the flowchart 500 depicts data exchanges between one STA and one other wireless device DEV, the present embodiments are equally applicable to data exchanges between multiple STAs and the DEV as well as between the STA and multiple other wireless devices.

An exemplary operation in which transmission conditions including a recovery time period for a STA are provided to another wireless device (DEV) is described below with respect to the illustrative flow chart 550 of FIG. 5B. For the exemplary operation described below, the other wireless device (DEV) may be an access point (e.g., AP 110 of FIG. 1) and/or another wireless station (e.g., one of stations STA1-STA3 of FIG. 1).

First, the STA may determine, identify, or retrieve one or more transmission conditions (for the STA) that include at least a recovery time period (REC_PER) (552). As mentioned above, the transmission conditions may be based, at least in part, upon the STA's hardware constraints, and may also include information indicating (i) a maximum duration of time (MAX_RX_PDU) that the STA can spend receiving an individual PDU from another wireless device, (ii) a maximum duration of time (MAX_TX_PDU) that the STA can spend transmitting a PDU to the other wireless device, and/or (iii) a minimum duration of time (MIN_INTER_PDU) that the other wireless device should wait after the transmission of a first PDU to the STA before sending a subsequent PDU to the STA.

For some embodiments, the STA's recovery time period may be predetermined and programmed (e.g., by the manufacturer of the STA) into memory resources of the STA (e.g., memory 240 of FIG. 2). For example, a value of REC_PER may be determined based upon the STA's specific battery features, hardware characteristics, and/or power consumption characteristics. During operation, the STA may retrieve the programmed transmission conditions from its memory resources. For other embodiments, the STA's transmission conditions may be determined by the STA and stored in its memory resources.

Next, the STA embeds the recovery time period into a frame to be sent to the other wireless device DEV (554), and then transmits the frame (along with the embedded recovery time period) to the other wireless device (556). As mentioned above, the frame sent from the STA to the DEV may be any suitable frame including, for example, association request frames, probe REQ frames, response frames, management frames, control frames, and/or data frames. For one example, if the DEV is an AP that has transmitted a beacon frame to the STA, the STA may embed the recovery time period into a response frame sent back to the DEV. Alternatively, if the STA has not received a beacon frame, the STA may embed the recovery time period into an association request frame or probe REQ frame to the DEV. For another example, if the DEV is another STA, then the STA may embed the recovery time period into an association request frame and/or other suitable frames exchanged between the devices (e.g., in a peer-to-peer or ad hoc wireless network).

Note that the STA may embed values for the recovery time period (and one or more other transmission conditions) into the capabilities element of the frame sent to the DEV. Alternatively, the STA may embed values for the recovery time period into a new information element of the frame sent to the DEV.

The DEV receives the frame from the STA, extracts the STA's recovery time period from the frame, and then stores the STA's recovery time period in its look-up table (e.g., transmission conditions table 332 of FIG. 3) (558). For example, as described above with respect to FIG. 4B, the DEV may use the STA's MAC address to access an entry 452 of transmission conditions table 450 that corresponds to the STA, and then store the STA's recovery time period in the corresponding entry 452 of transmission conditions table 450.

The DEV may determine a time when the STA enters the sleep state (560). The DEV may wait for the recovery time period after the determined time (562), and then transmit a number of PDUs to the STA only after an expiration of the recovery time period (564). The STA may thereafter receive the PDUs transmitted from the DEV (565). After expiration of the recovery time period, the DEV may also solicit a data transmission from the STA (566). The STA may thereafter transmit data to the DEV (567).

As describe above, the DEV may determine the time at which the STA enters the sleep state in a variety of ways. For one example, the DEV may determine the STA's sleep time in response to the time that the DEV receives an acknowledgement (ACK) frame from the STA acknowledging reception of buffered downlink data (e.g., in response to a PS-Poll request sent from the STA). For another example, the DEV may determine the STA's sleep time in response to the time that the DEV receives an ACK frame from the STA acknowledging reception of a frame having its End of Service Period (EOSP) bit asserted (e.g., set to 1). For another example, the DEV may determine the STA's sleep time in response to an adjusted awake time of the STA (e.g., modified in response to the STA's MAX_Awake_Time). For another example, the DEV may determine the STA's sleep time in response to the end time of a slot in the RAW of the STA. For another example, the DEV may determine the STA's sleep time in response to the end of transmission of a beacon frame from the DEV. For another example, the DEV may determine the STA's sleep time in response to the end of transmission of broadcast data following a DTIM from the DEV.

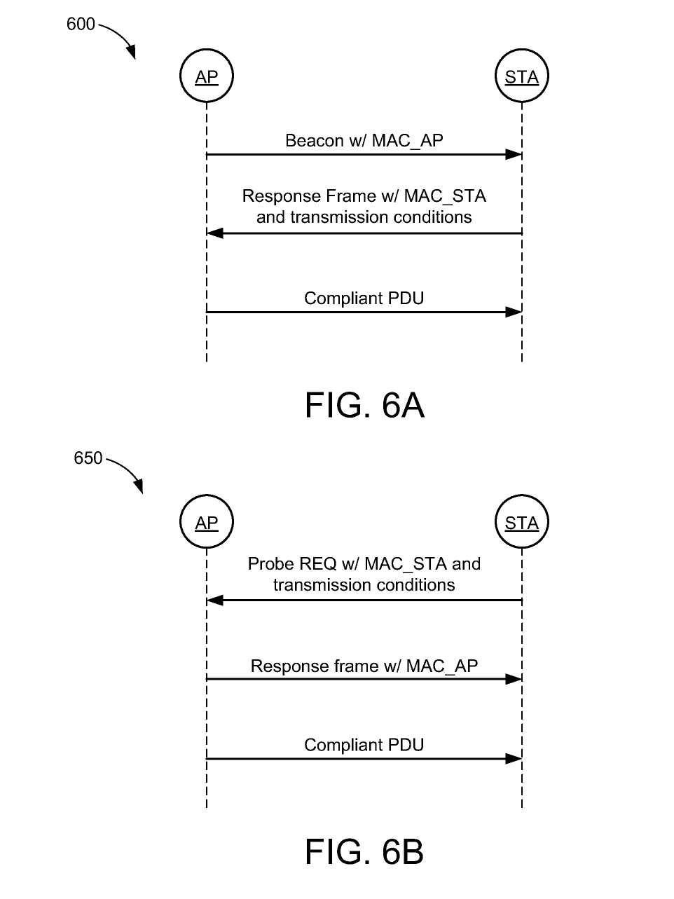

FIG. 6A shows a sequence diagram 600 depicting an exemplary operation in which a STA's transmission conditions may be provided to an access point (AP). The sequence diagram 600 depicts time in the vertical direction and depicts space in the horizontal direction. Although the sequence diagram 600 depicts only one AP and one STA, the operation may be performed between multiple STAs and the AP.

As depicted in FIG. 6A, the AP sends a beacon frame (e.g., as part of its broadcast schedule) to wireless stations STAs to advertise the presence of a WLAN. The beacon frame may include information about the network as well as the MAC address of the AP (MAC_AP). A STA that is within range of the AP may detect the beacon frame, process the information provided in the beacon frame, and then respond to the beacon frame by transmitting a response frame. The response frame, which as described above may be any suitable response frame, provides the AP with information to establish a communication channel or link between the AP and the STA. More specifically, the response frame may include the MAC address of the STA (MAC_STA) and one or more transmission conditions (e.g., MAX_RX_PDU, MAX_TX_PDU, and/or MIN_INTER_PDU). The AP may store the STA's transmission conditions in its transmission conditions table 400 (see also FIG. 4A). Once the wireless link is established between the AP and the STA, the AP can process PDUs that are to be transmitted to the STA based on the transmission conditions, and thereafter transmit PDUs that are compliant with the STA's transmission conditions.

FIG. 6B shows a sequence diagram 650 depicting another exemplary operation in which a STA's transmission conditions may be provided to an access point (AP). The sequence diagram 650 depicts time in the vertical direction and depicts space in the horizontal direction. Although the sequence diagram 650 depicts only one AP and one STA, the operation may be performed between multiple STAs and the AP.

As depicted in FIG. 6B, the STA transmits a probe request (REQ) frame to determine which APs are within the STA's range for establishing a wireless link. The probe REQ includes information about the STA such as the STA's MAC address (MAC_STA). The probe REQ may also include one or more transmission conditions (e.g., MAX_RX_PDU, MAX_TX_PDU, and/or MIN_INTER_PDU). In this manner, the STA may provide its transmission conditions to the AP without first receiving a beacon frame from the AP. The AP receives the probe REQ embedded with the STA's transmission conditions, and responds by sending to the STA a response frame having the AP's MAC address (MAC_AP). The AP may store the STA's transmission conditions in its transmission conditions table 400 (see also FIG. 4A). Once the wireless link is established between the AP and the STA, the AP can process PDUs that are to be transmitted to the STA based on the transmission conditions, and thereafter transmit PDUs that are compliant with the STA's transmission conditions.

By exchanging data in a manner that satisfies the transmission conditions, large sustained current peaks of a STA's battery may be reduced, which in turn may not only prevent degradation of the battery but also prevent the STA from overheating.

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for controlling transmission characteristics associated with an exchange of protocol data units (PDUs) between a first wireless device and a second wireless device, the method comprising:
receiving, in the second wireless device, a number of transmission conditions associated with the first wireless device, wherein the transmission conditions include a recovery time period associated with the first wireless device transitioning from a sleep state to an awake state;
determining a time when the first wireless device enters the sleep state;
waiting for the recovery time period after the determined time; and
transmitting a number of PDUs from the second wireless device to the first wireless device only after an expiration of the recovery time period.

2. The method of claim 1, wherein the transmission conditions are embedded within a capabilities element of a frame transmitted from the first wireless device to the second wireless device.

3. The method of claim 1, further comprising:
storing the transmission conditions in a look-up table provided within the second wireless device.

4. The method of claim 1, further comprising:
soliciting a data transmission from the first wireless device only after the expiration of the recovery time period.

5. The method of claim 1, wherein the determining comprises:
receiving an acknowledgement frame from the first wireless device acknowledging reception of downlink data transmitted from the second wireless device.

6. The method of claim 1, wherein the time corresponds to a most recent transmission of a beacon frame from the second wireless device to the first wireless device.

7. The method of claim 1, wherein the time corresponds to a most recent transmission of broadcast data from the second wireless device to the first wireless device.

8. The method of claim 1, wherein the time corresponds to an end of a slot in a restricted access window of the first wireless device.

9. The method of claim 1, wherein the first wireless device comprises a mobile station, and the second wireless device comprises an access point.

10. The method of claim 1, wherein the first wireless device comprises a first mobile station, and the second wireless device comprises a second mobile station.

11. A wireless device for controlling transmission characteristics associated with a wireless exchange of protocol data units (PDUs) with another device, wherein the wireless device comprises:
a transceiver to facilitate the exchange of PDUs; and
a processor to:
receive a recovery time period associated with the other device transitioning from a sleep state to an awake state;
determine a time when the other device enters the sleep state;
wait for the recovery time period after the determined time; and
transmit a number of PDUs to the other device only after an expiration of the recovery time period.

12. The wireless device of claim 11, wherein the recovery time period is embedded within a capabilities element of a frame transmitted from the other device.

13. The wireless device of claim 11, wherein the processor is to further:
store the transmission conditions in a look-up table provided within the wireless device.

14. The wireless device of claim 11, wherein the processor is to further:
solicit a data transmission from the other device only after the expiration of the recovery time period.

15. The wireless device of claim 11, wherein the processor is to determine the time by:
receiving an acknowledgement frame from the other device acknowledging reception of downlink data transmitted from the wireless device.

16. The wireless device of claim 11, wherein the time corresponds to a most recent transmission of a beacon frame from the wireless device.

17. The wireless device of claim 11, wherein the time corresponds to a most recent transmission of broadcast data from the wireless device.

18. The wireless device of claim 11, wherein the time corresponds to an end of a slot in a restricted access window of the other device.

19. The wireless device of claim 11, wherein the other device comprises a mobile station, and the wireless device comprises an access point.

20. The wireless device of claim 11, wherein the other device comprises a first mobile station, and the wireless device comprises a second mobile station.

21. A computer-readable storage medium containing program instructions that, when executed by a processor of a wireless device, cause the wireless device to:
receive a number of transmission conditions associated with another device, wherein the transmission conditions include a recovery time period associated with the other device transitioning from a sleep state to an awake state;
determine a time when the other device enters the sleep state;
wait for the recovery time period after the determined time; and
transmit a number of PDUs to the other device only after an expiration of the recovery time period.

22. The computer-readable storage medium of claim 21, wherein the transmission conditions are embedded within a capabilities element of a frame transmitted from the other device.

23. The computer-readable storage medium of claim 21, wherein execution of the program instructions further causes the wireless device to:
store the transmission conditions in a look-up table provided within the wireless device.

24. The computer-readable storage medium of claim 21, wherein execution of the program instructions further causes the wireless device to:
solicit a data transmission from the other device only after the expiration of the recovery time period.

25. The computer-readable storage medium of claim 21, wherein the time corresponds to receiving an acknowledgement frame from the other device acknowledging reception of downlink data transmitted from the wireless device.

26. The computer-readable storage medium of claim 21, wherein the time corresponds to a most recent transmission of a beacon frame from the wireless device.

27. The computer-readable storage medium of claim 21, wherein the time corresponds to a most recent transmission of broadcast data from the wireless device.

28. The computer-readable storage medium of claim 21, wherein the time corresponds to an end of a slot in a restricted access window of the other device.

29. The computer-readable storage medium of claim 21, wherein the other device comprises a mobile station, and the wireless device comprises an access point.

30. The computer-readable storage medium of claim 21, wherein the other device comprises a first mobile station, and the wireless device comprises a second mobile station.

31. A wireless device for controlling transmission characteristics associated with a wireless exchange of protocol data units (PDUs) with another device, wherein the wireless device comprises:
means for receiving a recovery time period associated with the other device transitioning from a sleep state to an awake state;
means for determining a time when the other device enters the sleep state;
means for waiting for the recovery time period after the determined time; and
means for transmitting a number of PDUs from the wireless device to the other device only after an expiration of the recovery time period.

32. The wireless device of claim 31, wherein the recovery time period is embedded within a capabilities element of a frame transmitted from the other device to the wireless device.

33. The wireless device of claim 31, further comprising:
means for soliciting a data transmission from the other device only after the expiration of the recovery time period.

34. The wireless device of claim 31, wherein the time corresponds to a most recent transmission of a beacon frame from the wireless device.

35. The wireless device of claim 31, wherein the time corresponds to a most recent transmission of broadcast data from the wireless device.

36. The wireless device of claim 31, wherein the time corresponds to an end of a slot in a restricted access window of the other device.
